(19) United States
(12) Patent Application Publication
(10) Pub. No.: US 2011/0273493 A1
(43) Pub. Date: Nov. 10, 2011

(54) PIXEL STRUCTURE AND DISPLAY DEVICE HAVING THE SAME

(75) Inventors: Masahiro Yoshiga, Hyogo (JP); Naoki Sumi, Hyogo (JP)

(73) Assignee: CHIMEI INNOLUX CORPORATION, Miaoli County (TW)

(21) Appl. No.: 12/776,550

(22) Filed: May 10, 2010

(51) Int. Cl. G09G 5/02

(52) U.S. Cl. 345/694

(57) ABSTRACT

A pixel structure, a display device and an electronic device are provided. The pixel structure includes three primary sub-pixels of a first color, a second color, and a third color; three secondary sub-pixels of a fourth color, a fifth color, and a sixth color; and a logic circuit. The logic circuit includes three input terminals and three output terminals, and a voltage of each of the three output terminals is corresponding to a logic combination of voltages of the three input terminals. The three input terminals are coupled to the three primary sub-pixels respectively, while the three output terminals are coupled to the three secondary sub-pixels respectively.

### FIELD OF INVENTION

The present invention relates to a liquid crystal display (LCD) device, and more particularly to a liquid crystal display device including six-color sub-pixels.

### BACKGROUND OF THE INVENTION

A liquid crystal display (LCD) device is one of the most widely used flat panel displays, and is used in a large variety of applications, from small-sized device (such as a mobile phone or a digital camera) to large-sized devices (such as televisions or computer monitors). Typically, the LCD device uses three primary colors of red, green, and blue to display images. In order to offer more natural and realistic images, the display devices provided with six primary colors have been developed.

FIG. 1 shows a conventional circuit block diagram of a pixel structure 100 of a six-primary-color display device. The pixel structure 100 includes a red sub-pixel 130, a green sub-pixel 140, a blue sub-pixel 150, a yellow sub-pixel 160, a cyan sub-pixel 170, and a magenta sub-pixel 180, and each sub-pixel includes a thin-film transistor (TFT) and a LC capacitor. As shown in FIG. 1, two gate lines 110 and 112 and three data lines 120, 122, and 124 are required to drive these six sub-pixels 130-180. Compared with the display device of three primary colors (red, green, and blue), the six-primary-color display can provide finer gradation and better color reproduction, but may lead to an increase of the number of gate lines which affects the aperture ratio of the pixel structure 100 and further degrades the display quality of the display device.

Therefore, it is desired to have a six-primary-color display device with less additional data lines or gate lines.

### SUMMARY OF THE INVENTION

In light of the problems of the prior art, some embodiments of the present invention provide a six-primary-color display device which can be implemented without additional gate lines and data lines with memory-in-pixel (MIP) mode.

According to one aspect of some embodiments, a pixel structure is provided. The pixel structure of the embodiments includes three primary sub-pixels of a first color, a second color, and a third color; a logic circuit; and three secondary sub-pixels of a fourth color, a fifth color, and a sixth color. The logic circuit has three input terminals and three output terminals, and a voltage of each of the three output terminals is corresponding to a logic combination of voltages of the three input terminals. The three primary sub-pixels are coupled to the three input terminals respectively, and the three secondary sub-pixels are coupled to the three output terminals respectively.

According to another aspect of some embodiments, a display device is provided. The display device of the embodiments includes a liquid crystal panel, a gate driving circuit, and a data driving circuit. The liquid crystal panel includes a plurality of the above-described pixel structures arranged as rows and columns, a plurality of gate lines driven by the gate driving circuit, and a plurality of data lines driven by the data driving circuit, and each pixel structure coupled to one gate line and three data lines.

Other aspects of some embodiments would be stated and easily understood through the following description or the embodiments of the embodiments. The aspects of the present invention would be appreciated and implemented by the elements and their combinations pointed out in the appended claims. It should be understood that the above summary of the invention and the following detailed description are only illustrative but not to limit the present invention.

### BRIEF DESCRIPTION OF THE DRAWINGS

The drawings are employed to illustrate the embodiments and the principles of the present invention in conjunction with the description. However, it should be understood that the present invention is not limited to the shown configurations and elements, in which:

FIG. 1 shows a conventional circuit block diagram of a pixel structure of a six-primary-color display;

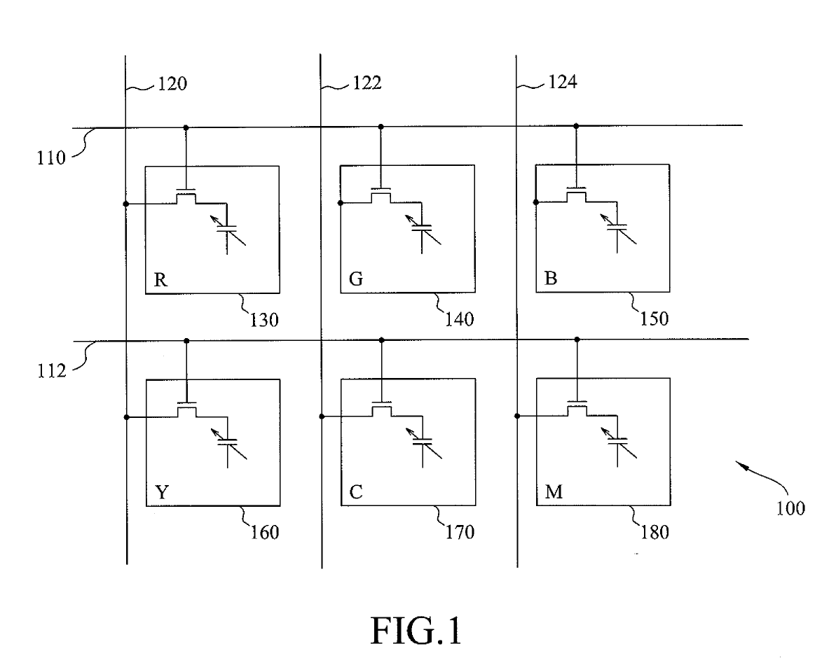

FIG. 2 is a block diagram of an electronic device according to one embodiment of the present invention;

FIG. 3 is a circuit block diagram of a logic circuit according to one embodiment of the present invention; and

FIG. 4 depicts a circuit diagram of a pixel structure according to one embodiment of the present invention.

### DETAILED DESCRIPTION OF THE PREFERRED EMBODIMENTS

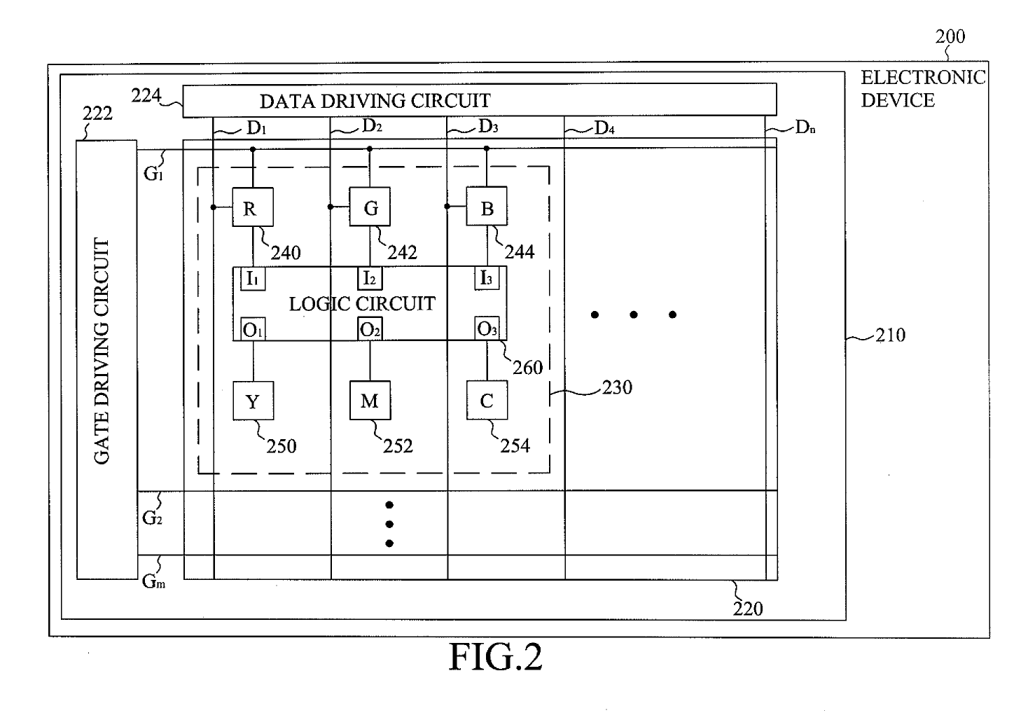

A six-primary-color display device is disclosed, which can be implemented without additional lines with memory-in-pixel (MIP) mode. The objects, features and advantages of the present invention would be more apparent by referring to the following description of the preferred embodiments and FIGS. 2-4. However, the apparatuses, elements, and steps of the method described in the following embodiments are intended to illustrate the present invention, but not to limit the scope of the invention.

FIG. 2 is a block diagram of an electronic device 200 according to one embodiment of the present invention, which includes a display device 210 to display images. In this embodiment, the electronic device 200 could be any one of a variety of devices, including but not limited to, a mobile phone, a digital camera, a personal digital assistant (PDA), a notebook computer, a desktop computer, a television, a global positioning system (GPS), a car media player, an avionics display, a digital photo frame, a portable video player, etc.

The display device 210 includes a liquid crystal panel 220, a gate driving circuit 222, and a data driving circuit 224. The liquid crystal panel 220 includes a plurality of pixel structures arranged as rows and columns. The gate driving circuit 222 is configured to input control signals to a plurality of gate lines G₁, G₂, . . . , Gₘ for driving the pixel structures of the liquid crystal panel 220, and the data driving circuit 224 is configured to provide data signals to a plurality of data lines D₁, D₂, . . . , Dₙ. Typically, each pixel structure of the liquid crystal panel 220 is coupled to one gate line and three data lines.

As shown in FIG. 2, one pixel structure 230 of the liquid crystal panel 220 includes three primary sub-pixels 240, 242, 244, three secondary sub-pixels 250, 252, 254 and a logic circuit 260. Typically, the colors of these six sub-pixels 240, 242, 244, 250, 252, and 254 are different from one another. In this embodiment, the primary sub-pixels 240, 242, 244 are red, green, and blue sub-pixels respectively, and the secondary sub-pixels 250, 252, 254 are yellow, magenta, and cyan sub-pixels respectively, but note that the present invention is not limited to this embodiment. For example, in an alternative embodiment, the colors of the primary sub-pixels 240, 242, 244 can be yellow, magenta, and cyan respectively, and the colors of the secondary sub-pixels 250, 252, 254 can be red, green, and blue respectively.

In the embodiment shown in FIG. 2, the three primary sub-pixels 240, 242, 244 are all connected to the gate line G₁ and are respectively connected to three data lines D₁, D₂, and D₃. Specifically, the sub-pixel 240 is controlled by the gate line G₁ and the data line D₁, the sub-pixel 242 is controlled by the gate line G₁ and the data line D₂, and the sub-pixel 244 is controlled by the gate line G₁ and the data line D₃.

The logic circuit 260 includes three input terminals I₁, I₂, I₃ and three output terminals O₁, O₂, O₃. The input terminals I₁, I₂, I₃ are respectively coupled to the pixel electrodes (not labeled in FIG. 2) of the three primary sub-pixels 240, 242, and 244. The voltage presented at each of the three output terminals O₁, O₂, O₃ is corresponding to a logic combination of the voltages applied at the three input terminals I₁, I₂, I₃. Specifically, the logic circuit 260 is configured such that a voltage level of at least one of the output terminal O₁, O₂, O₃ is determined by an output value of AND logic between at least two of the input terminals I₁, I₂, I₃. The output terminals O₁, O₂, O₃ are respectively coupled to the pixel electrodes (not labeled in FIG. 2) of the three secondary sub-pixels 250, 252, and 254 for driving the secondary sub-pixels 250, 252, and 254. Therefore, the status (on or off) of the secondary sub-pixels 250, 252, and 254 can be set by controlling the voltages outputted from the primary sub-pixels 240, 242, and 244, without the need of additional gate line or data line.

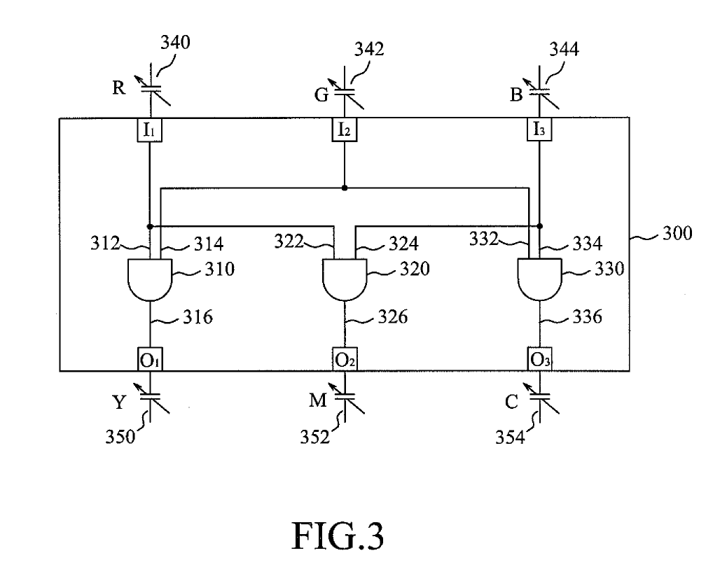

FIG. 3 is an exemplary circuit block diagram of the logic circuit shown in FIG. 2 according to one embodiment of the present invention. Referring to FIG. 3, the logic circuit 300 is constituted of a first AND logic gate 310, a second AND logic gate 320, and a third AND logic gate 330, and has three input terminals I₁, I₂, I₃ and three output terminals O₁, O₂, O₃ which are respectively coupled to the pixel electrodes of red (R), green (G), blue (B), yellow (Y), magenta (M), and cyan (C) sub-pixels 340, 342, 344, 350, 352, and 354.

In this embodiment, the three AND logic gates 310, 320, and 330 are all a 2-input AND logic gate. As shown in FIG. 3, the first input 312, the second input 314, and the output 316 of the first AND logic gate 310 are coupled to the red, green, and yellow sub-pixels 340, 342, and 350 respectively. Similarly, the first input 322, the second input 324, and the output 326 of the second AND logic gate 320 are coupled to the red, blue, and magenta sub-pixels 340, 344, and 352 respectively; also the first input 332, the second input 334, and the output 336 of the third AND logic gate 330 are coupled to the green, blue, and cyan sub-pixels 342, 344, and 354 respectively.

As those skilled in the art should understand, yellow, magenta, or cyan color can be formed by adding two of red, green, and blue colors of equal intensity. In particular, yellow is consisted of red and green, magenta is consisted of red and blue, and cyan is consisted of green and blue. Therefore, referring to the logic circuit 300 in FIG. 3, the yellow sub-pixel 350 can be turned on when both of the red and green sub-pixels 340 and 342 are driven into the ON state, and the magenta and cyan sub-pixels 352 and 354 are subjected to the similar relationship with the corresponding primary sub-pixels. Consequently, with the logic circuit 300, there is no need to provide additional gate line or data line to drive the secondary sub-pixels 350, 352, and 354.

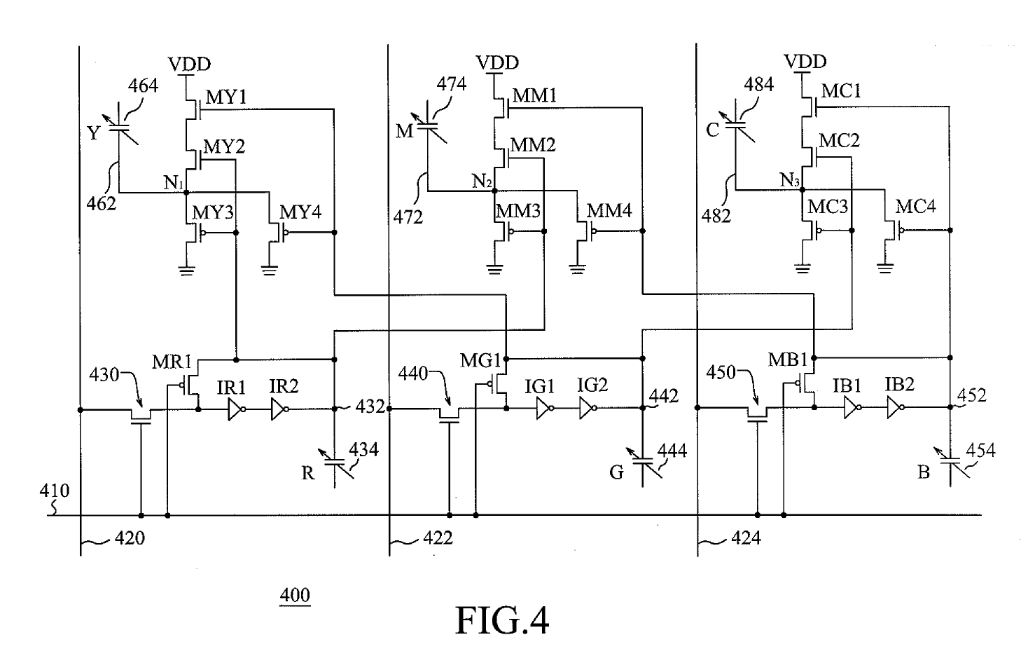

FIG. 4 depicts a circuit diagram of the pixel structure 400 according to one embodiment of the present invention. The pixel structure 400 includes three primary sub-pixels, three secondary sub-pixels, and a logic circuit, a more detailed description of which will be given below. In this embodiment, the colors of three primary sub-pixels are red, green, and blue, and each of them includes an embedded memory therein. Corresponding to the colors of the primary sub-pixels, the colors of three secondary sub-pixels are yellow, magenta, and cyan.

Referring to FIG. 4, the red sub-pixel includes a transistor 430 (implemented as a N-type transistor in this embodiment), a SRAM unit constituted of a SRAM switching element MR1 and two inverters IR1 and IR2, a pixel electrode 432, and a LC capacitor 434. The gate of the transistor 430 is connected to a gate line 410, whereby the on/off thereof can be controlled through the gate line 410. Moreover, the drain of the transistor 430 is connected to a data line 420 and the source of the transistor 430 is connected to an input of the inverter IR1. An output of the inverter IR1 is connected to an input of the inverter IR2, and an output of the inverter IR2 is connected to the pixel electrode 432. The SRAM switching element MR1 is configured to selectively conduct an electrical connection between the pixel electrode 432 and the input of the inverter IR1, which is implemented as a P-type transistor in this embodiment. The gate of the SRAM switching element MR1 is connected to the gate line 410, whereby the on/off thereof can be controlled through the gate line 410. Therefore, the on/off states of the transistor 430 and the SRAM switching element MR1 are in a relation reverse to each other, i.e. when the transistor 430 is turned on, the SRAM switching element MR1 is turned off, and vice versa.

In a write mode, the transistor 430 is turned on and the SRAM switching element MR1 is turned off, such that the data signal transmitted through the data line 420 can be written into the inverters IR1 and IR2. Then, the transistor 430 is turned off and the SRAM switching element MR1 is turned on, such that the data signal can be held by the closed loop formed by the inverters IR1, IR2 and the SRAM switching element MR1. In other words, the red sub-pixel has a function of holding the data signal until the red sub-pixel is selected and written next time.

Also referring to FIG. 4, similar to the red sub-pixel, the green sub-pixel includes a transistor 440, a SRAM unit constituted of a SRAM switching element MG1 and two inverters IG1 and IG2, a pixel electrode 442, and a LC capacitor 444; likewise the blue sub-pixel includes a transistor 450, a SRAM unit constituted of a SRAM switching element MB1 and two inverters IB1 and IB2, a pixel electrode 452, and a LC capacitor 454. The functions of the elements within the green and blue sub-pixels are the same as that within the red sub-pixel, so the detail description thereof is omitted.

Referring to the secondary sub-pixels, the yellow sub-pixel includes a pixel electrode 462 and a LC capacitor 464, the magenta sub-pixel includes a pixel electrode 472 and a LC capacitor 474, and cyan sub-pixel includes a pixel electrode 482 and a LC capacitor 484. The secondary sub-pixels of the present invention, unlike the conventional ones, do not include transistors needed to be driven by additional gate lines.

The logic circuit of the pixel structure 400 shown in FIG. 4 includes a first AND logic gate constituted of a pair of NMOS MY1 and MY2 and a pair of PMOS MY3 and MY4, a second AND logic gate constituted of a pair of NMOS MM1 and MM2 and a pair of PMOS MM3 and MM4, and a third AND logic gate constituted of a pair of NMOS MC1 and MC2 and a pair of PMOS MC3 and MC4. The output nodes N₁, N₂, and N₃ of these three AND logic gates are respectively coupled to the pixel electrodes 462, 472, and 482.

The drain of the NMOS MY1 is connected to a power source line (VDD) and the source of the NMOS MY1 is connected to the drain of the NMOS MY2. The source of the NMOS MY2, i.e. the output node N₁, is connected to both of the sources of the PMOS MY3 and the PMOS MY4, and both of the drains of the PMOS MY3 and the PMOS MY4 are connected to a ground line. Moreover, the gates of the NMOS MY2 and PMOS MY3 are connected to the pixel electrode 432 of the red sub-pixel, and the gates of NMOS MY1 and PMOS MY4 are connected to the pixel electrode 442 of the green sub-pixel. The output node N₁ as well as the pixel electrode 462 of the yellow sub-pixel will be high only when both of the voltage levels on the pixel electrode 432 and the pixel electrode 442 are high (i.e. the NMOS MY1 and the NMOS MY2 are turned on and the PMOS MY3 and the PMOS MY4 are turned off). In other words, the yellow sub-pixel can be turned on by driving both of the red and green sub-pixels to an ON state. Similar to the concept described above with respect to the yellow sub-pixel, the state of magenta sub-pixel can be set by manipulating the voltages on the pixel electrode 432 of the red sub-pixel and the pixel electrode 452 of the blue sub-pixel, and the state of cyan sub-pixel can be set by controlling the voltages on the pixel electrode 442 of the green sub-pixel and the pixel electrode 452 of the blue sub-pixel.

As described above, according to one aspect of the present invention, the aperture ratio of the six-primary-color display device can be improved by reducing the number of the required lines. In accordance with one embodiment of the present invention, a logic circuit is built within each pixel structure, whereby the yellow, magenta, and cyan sub-pixels can be controlled through the logic combination of the output voltages of the red, green, and blue sub-pixels without adding additional gate lines, data lines, power lines, or grounding lines. Furthermore, the total number of the transistors within one pixel structure can also be reduced, which may allow a further brightness increase as it may allow an increase of pixel aperture. It should be noted that, as those skilled in the art should understand, the circuit structures described above are intended only for illustration and not intended to limit the present invention. For example, the SRAM unit can be replaced with a DRAM unit.

While this invention has been described with reference to the illustrative embodiments, these descriptions should not be construed in a limiting sense. Various modifications of the illustrative embodiment, as well as other embodiments of the invention, will be apparent upon reference to these descriptions. It is therefore contemplated that the appended claims will cover any such modifications or embodiments as falling within the true scope of the invention and its legal equivalents.

We claim:

1. A pixel structure, comprising:
three primary sub-pixels of a first color, a second color, and a third color;
a logic circuit having three input terminals and three output terminals, a voltage of each of the three output terminals corresponding to a logic combination of voltages of the three input terminals, the three input terminals coupled to the three primary sub-pixels respectively; and
three secondary sub-pixels of a fourth color, a fifth color, and a sixth color, the three secondary sub-pixels coupled to the three output terminals respectively, wherein the first color, the second color, the third color, the fourth color, the fifth color, and the sixth color are different from one another.

2. The pixel structure according to claim 1, wherein each of the three primary sub-pixels comprises a transistor, and a pixel electrode electrically coupled to the thin film transistor, wherein the three input terminals of the logic circuit are coupled to pixel electrodes of the three primary sub-pixels respectively.

3. The pixel structure according to claim 2, wherein transistors of the three primary sub-pixels are all connected to one gate line and are connected to three data lines respectively.

4. The pixel structure according to claim 1, wherein each of the three secondary sub-pixels comprises a pixel electrode, and the three output terminals of the logic circuit are coupled to pixel electrodes of the three secondary sub-pixels respectively.

5. The pixel structure according to claim 1, wherein logic circuit is configured such that a voltage level of at least one output terminal is determined by a combination of voltage levels of at least two input terminals.

6. The pixel structure according to claim 5, wherein the logic circuit comprises three AND logic gates.

7. The pixel structure according to claim 1, wherein each of the primary sub-pixels comprises an embedded memory.

8. The pixel structure according to claim 7, wherein the embedded memory is a SRAM unit comprising two inverters and one SRAM switching element.

9. The pixel structure according to claim 1, wherein the first color, the second color, and the third color are red, green, and blue respectively.

10. The pixel structure according to claim 1, wherein the fourth color, the fifth color and the sixth color are yellow, magenta, and cyan respectively.

11. A display device, comprising:
a liquid crystal panel comprising a plurality of pixel structures of claim 1 arranged as rows and columns, a plurality of gate lines, and a plurality of data lines, and each pixel structure coupled to one gate line and three data lines;
a gate driving circuit configured to provide a control signal to the plurality of gate lines; and
a data driving circuit configured to provide a data signal to the plurality of data lines.

12. The display device according to claim 11, wherein the first color, the second color, the third color, the fourth color, the fifth color, and the sixth color are red, green, blue, yellow, magenta, and cyan respectively;
wherein the logic circuit comprises a first AND logic gate, a second AND logic gate, and a third AND logic gate;
wherein the first AND logic gate comprising a first input coupled to the primary sub-pixel of red, a second input coupled to the primary sub-pixel of green, and an output coupled to the secondary sub-pixel of yellow;
wherein the second AND logic gate comprising a first input coupled to the primary sub-pixel of red, a second input coupled to the primary sub-pixel of blue, and an output coupled to the secondary sub-pixel of magenta; and
wherein the third AND logic gate comprising a first input coupled to the primary sub-pixel of green, a second input coupled to the primary sub-pixel of blue, and an output coupled to the secondary sub-pixel of cyan.

13. The display device according to claim 12, wherein each of the primary sub-pixels comprises an embedded memory.

14. An electronic device, comprising a display device of claim 11.

15. The electronic device according to claim 14, wherein the electronic device is a mobile phone, a digital camera, a personal digital assistant (PDA), a notebook computer, a desktop computer, a television, a global positioning system (GPS), a car media player, an avionics display, a digital photo frame, or a portable video player.
